(19) United States
(12) Patent Application Publication
(10) Pub. No.: US 2023/0392549 A1
(43) Pub. Date: Dec. 7, 2023

(54) ELECTRICAL ASSISTED ICE REDUCTION MECHANISMS FOR GAS TURBINE ENGINE OR AIRCRAFT

(71) Applicants: General Electric Company, Schenectady, NY (US); General Electric Deutschland Holding GmbH, Frankfurt (DE)

(72) Inventors: Ashish Sharma, Munich (DE); Antonio Guijarro Valencia, Munich (DE); Paolo Vanacore, Munich (DE); Scott Alan Schimmels, Miamisburg, OH (US); Rajani Bhanu Poornima M, Bengaluru (IN); Vishnu Vardhan Venkata Tatiparthi, Bengaluru (IN); Prateek Mathur, Bengaluru (IN); Vilas Kawaduji Bokade, Bengaluru (IN)

(21) Appl. No.: 18/081,783

(22) Filed: Dec. 15, 2022

(30) Foreign Application Priority Data
Jun. 3, 2022 (IN) 202211031898

(51) Int. Cl. F02C 7/047; B64D 15/12; C09D 1/00; C09D 5/00

(52) U.S. Cl. CPC F02C 7/047; B64D 15/12; C09D 1/00; C09D 5/00; F05D 2220/323; F05D 2260/20

(57) ABSTRACT

A gas turbine engine is provided. The gas turbine engine includes a fan comprising a plurality of fan blades; a turbomachine operably coupled to the fan for driving the fan, the turbomachine comprising a compressor section, a combustion section, and a turbine section in serial flow order and together defining a core air flowpath; and one or more graphene layers coupled to, or integrated into, a portion of the gas turbine engine, wherein the one or more graphene layers are configured to reduce ice buildup or ice formation. The one or more graphene layers include graphene or an allotrope thereof.

### PRIORITY INFORMATION

The present application claims priority to Indian Patent Application Number 202211031898 filed on Jun. 3, 2022.

### TECHNICAL FIELD

The present subject matter relates generally to a gas turbine engine, or more particularly to a gas turbine engine having features to reduce ice buildup or ice formation on components of the engine.

### BACKGROUND

A turbofan engine generally includes a fan having a plurality of fan blades and a turbomachine arranged in flow communication with one another. Additionally, the turbomachine of the turbofan engine generally includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gasses through the turbine section drives the turbine section and is then routed through the exhaust section, e.g., to atmosphere.

However, during inclement weather, freezing rain, hail, sleet, ice, etc., can accumulate on the inlet components of the turbofan engine. When ice accumulates, it can break off and be ingested into the engine. Further, large portions of ice can damage the fan blades, other downstream components of the engine, or aircraft components, and may potentially cause an engine flameout.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic cross-sectional view of an exemplary gas turbine engine according to an exemplary embodiment of the present subject matter.

FIG. 2A is a close-up, schematic, cross-sectional view of a component of the exemplary gas turbine engine of FIG. 1 having one or more graphene layers coupled to an external surface of the component according to an exemplary embodiment of the present subject matter.

FIG. 2B is a close-up, schematic, cross-sectional view of a component of the exemplary gas turbine engine of FIG. 1 having one or more graphene layers coupled to, or integrated into, an interior surface of the component according to another exemplary embodiment of the present subject matter.

FIG. 3 is a close-up, cross-sectional view of a portion of a fan blade provided with one or more graphene layers according to another exemplary embodiment of the present subject matter.

FIG. 4 it is a close-up, cross-sectional view of a portion of an air splitter portion provided with one or more graphene layers according to another exemplary embodiment of the present subject matter.

FIG. 5 is a close-up, cross-sectional view of a portion of an outlet guide vane provided with one or more graphene layers according to another exemplary embodiment of the present subject matter.

FIG. 6 is a close-up, cross-sectional view of a portion of an inlet guide vane provided with one or more graphene layers according to another exemplary embodiment of the present subject matter.

FIG. 7 is a top view of an exemplary aircraft provided with one or more graphene layers according to another exemplary embodiment of the present subject matter.

FIG. 8 is a cross-sectional view of a fan section and a turbomachine of a turbofan engine provided with one or more graphene layers according to another exemplary embodiment of the present subject matter.

FIG. 9 provides a block diagram of a control system for controlling a gas turbine engine in accordance with exemplary embodiments of the present disclosure.

FIG. 10 is a flow diagram of an exemplary method of monitoring conditions of components of a turbofan engine and causing an electrical system to provide power to electrical heating elements in accordance with exemplary embodiments of the present disclosure.

FIG. 11 is an example computing system according to example embodiments of the present disclosure.

FIG. 12 is a cross-sectional view of a fan section and a turbomachine of a turbofan engine including an anti-icing system having a first anti-icing component in contact with an electrical supply assembly and a second anti-icing component that is not in contact with the electrical supply assembly according to another exemplary embodiment of the present subject matter.

FIG. 13 is a cross-sectional view of a fan section and a turbomachine of a turbofan engine including an anti-icing system having a first anti-icing component in contact with an electrical supply assembly and a second anti-icing component that is not in contact with the electrical supply assembly according to another exemplary embodiment of the present subject matter.

FIG. 14 is a close-up, schematic, cross-sectional view of a first anti-icing component that is coupled to a first engine component of a turbofan engine according to another exemplary embodiment of the present subject matter.

FIG. 15 is a close-up, schematic, cross-sectional view of a first anti-icing component that is coupled to a first engine component of a turbofan engine according to another exemplary embodiment of the present subject matter.

FIG. 16 is a close-up, schematic, cross-sectional view of a second anti-icing component that is coupled to a second engine component of a turbofan engine according to another exemplary embodiment of the present subject matter.

FIG. 17 is a close-up, schematic, cross-sectional view of a second anti-icing component that is coupled to a second engine component of a turbofan engine according to another exemplary embodiment of the present subject matter.

FIG. 18 provides a block diagram of a control system for controlling an anti-icing system in accordance with exemplary embodiments of the present disclosure.

FIG. 19 is a schematic cross-sectional view of an exemplary gas turbine engine according to another exemplary embodiment of the present subject matter.

Corresponding reference characters indicate corresponding parts throughout the several views. The exemplifications set out herein illustrate exemplary embodiments of the disclosure, and such exemplifications are not to be construed as limiting the scope of the disclosure in any manner.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The following description is provided to enable those skilled in the art to make and use the described embodiments contemplated for carrying out the disclosure. Various modifications, equivalents, variations, and alternatives, however, will remain readily apparent to those skilled in the art. Any and all such modifications, variations, equivalents, and alternatives are intended to fall within the scope of the present disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

For purposes of the description hereinafter, the terms “upper”, “lower”, “right”, “left”, “vertical”, “horizontal”, “top”, “bottom”, “lateral”, “longitudinal”, and derivatives thereof shall relate to the disclosure as it is oriented in the drawing figures. However, it is to be understood that the disclosure may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

As used herein, the terms “first”, “second”, and “third” may be used interchangeably to distinguish one component from another and are not intended to signify location or importance of the individual components.

The terms “forward” and “aft” refer to relative positions within a gas turbine engine, with forward referring to a position closer to an engine inlet and aft referring to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The singular forms “a”, “an”, and “the” include plural references unless the context clearly dictates otherwise.

Additionally, the terms “low,” “high,” or their respective comparative degrees (e.g., lower, higher, where applicable) each refer to relative speeds or pressures within an engine, unless otherwise specified. For example, a “low-pressure turbine” operates at a pressure generally lower than a “high-pressure turbine.” Alternatively, unless otherwise specified, the aforementioned terms may be understood in their superlative degree. For example, a “low-pressure turbine” may refer to the lowest maximum pressure turbine within a turbine section, and a “high-pressure turbine” may refer to the highest maximum pressure turbine within the turbine section. An engine of the present disclosure may also include an intermediate pressure turbine, e.g., an engine having three spools.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The present disclosure is generally related to components of a gas turbine engine provided with one or more graphene layers to reduce ice buildup or ice formation on the components of the gas turbine engine. It is contemplated that graphene or any of its allotropes, e.g., carbon allotropes, carbon nanotubes, fullerene, or similar material, may be used in this manner to reduce ice buildup or ice formation on the components of the turbofan engine. The graphene anti-ice systems of the present disclosure reduce the weight and complexity of conventional anti-ice systems.

Graphene is strong, flexible, impermeable to molecules, and highly electrically and thermally conductive. Furthermore, graphene combines the strength and light weight properties of the carbon network allotropes. Graphene also has a lower deterioration rate than conventional materials such as thermal barrier coatings. As such, graphene provides additional benefits including higher cycle operations.

Graphene has a melting temperature of about 5000 K (about 4727.degree. C.) and has remarkable properties withstanding flame. The conductivity of graphene is anisotropic, and graphene can be used as an insulating material. Graphene also has better impact resistance than Kevlar.

The high conductivity of graphene and the possibility of adapting to any existing structure given the high melting point of graphene make the incorporation of one or more graphene layers particularly useful for components of the gas turbine engine in high temperature environments and to reduce ice buildup or ice formation on the components of the turbofan engine. Each layer of graphene is monoatomic and therefore minimally intrusive and can be piled.

In further exemplary embodiments of the present disclosure, an electrical heating element is disposed in thermal communication with the graphene layers. In this manner, the electrical heating element provides heat to the graphene layers to help reduce ice buildup or ice formation on the components of the gas turbine engine.

Inclusion of these features of the present disclosure provides an anti-icing or de-icing mechanism that may prevent the buildup and shedding of pieces of ice into the engine during, e.g., adverse weather conditions, potentially resulting in safer operation of the gas turbine engine.

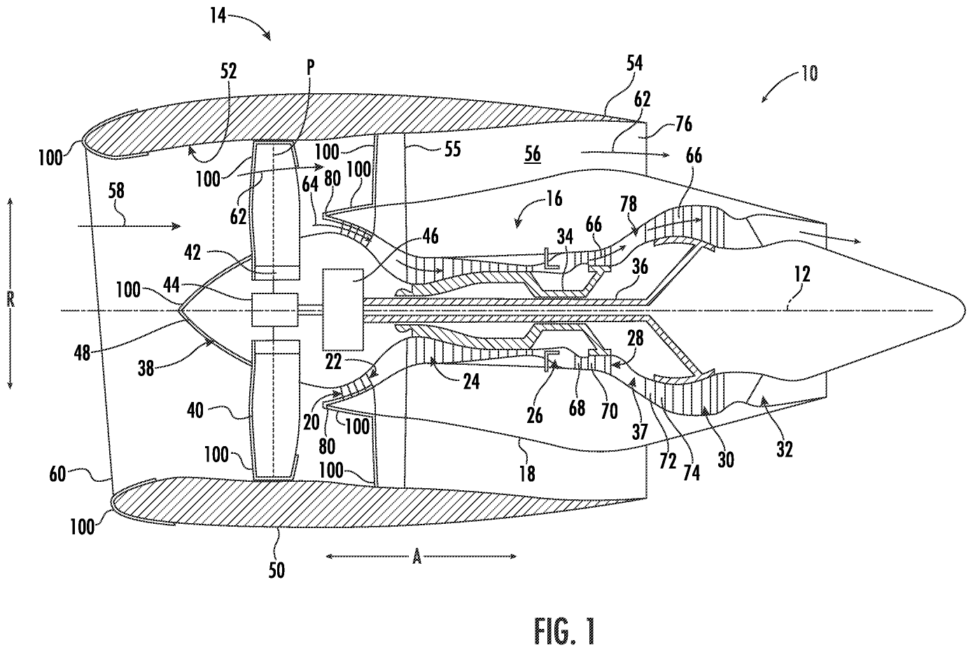

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine engine is an aeronautical, turbofan jet engine 10, referred to herein as “turbofan engine 10”, configured to be mounted to an aircraft, such as in an under-wing configuration or tail-mounted configuration. As shown in FIG. 1, the turbofan engine 10 defines an axial direction A (extending parallel to a longitudinal centerline 12 provided for reference), a radial direction R, and a circumferential direction (i.e., a direction extending about the axial direction A; not depicted). In general, the turbofan engine 10 includes a fan section 14 and a turbomachine 16 disposed downstream from the fan section 14 (the turbomachine 16 sometimes also, or alternatively, referred to as a “core turbine engine”).

The exemplary turbomachine 16 depicted generally includes a substantially tubular outer casing 18 that defines an annular inlet 20. The outer casing 18 encases, in serial flow relationship, a compressor section including a first, booster or low pressure (LP) compressor 22 and a second, high pressure (HP) compressor 24; a combustion section 26; a turbine section including a first, high pressure (HP) turbine 28 and a second, low pressure (LP) turbine 30; and a jet exhaust nozzle section 32. A high pressure (HP) shaft 34 drivingly connects the HP turbine 28 to the HP compressor 24. A low pressure (LP) shaft 36 drivingly connects the LP turbine 30 to the LP compressor 22. The compressor section, combustion section 26, turbine section, and jet exhaust nozzle section 32 are arranged in serial flow order and together define a core air flowpath 37 through the turbomachine 16. It is also contemplated that the present disclosure is compatible with an engine having an intermediate pressure turbine, e.g., an engine having three spools.

Referring still the embodiment of FIG. 1, the fan section 14 includes a variable pitch, single stage fan 38, the turbomachine 16 operably coupled to the fan 38 for driving the fan 38. The fan 38 includes a plurality of rotatable fan blades 40 coupled to a disk 42 in a spaced apart manner. As depicted, the fan blades 40 extend outwardly from disk 42 generally along the radial direction R. Each fan blade 40 is rotatable relative to the disk 42 about a pitch axis P by virtue of the fan blades 40 being operatively coupled to a suitable actuation member 44 configured to collectively vary the pitch of the fan blades 40, e.g., in unison. The fan blades 40, disk 42, and actuation member 44 are together rotatable about the longitudinal centerline 12 by LP shaft 36 across a power gear box 46. The power gear box 46 includes a plurality of gears for stepping down the rotational speed of the LP shaft 36 to a more efficient rotational fan speed. Accordingly, for the embodiment depicted, the turbomachine 16 is operably coupled to the fan 38 through the power gear box 46.

In exemplary embodiments, the fan section 14 includes twenty-two (22) or fewer fan blades 40. In certain exemplary embodiments, the fan section 14 includes twenty (20) or fewer fan blades 40. In certain exemplary embodiments, the fan section 14 includes eighteen (18) or fewer fan blades 40. In certain exemplary embodiments, the fan section 14 includes sixteen (16) or fewer fan blades 40. In certain exemplary embodiments, it is contemplated that the fan section 14 includes other number of fan blades 40 for a particular application.

Referring still to the exemplary embodiment of FIG. 1, the disk 42 is covered by rotatable front nacelle or hub 48 aerodynamically contoured to promote an airflow through the plurality of fan blades 40. Additionally, the exemplary fan section 14 includes an annular fan casing or outer nacelle 50 that at least partially, and for the embodiment depicted, circumferentially, surrounds the fan 38 and at least a portion of the turbomachine 16.

More specifically, the outer nacelle 50 includes an inner wall 52 and a downstream section 54 of the inner wall 52 of the outer nacelle 50 extends over an outer portion of the turbomachine 16 so as to define a bypass airflow passage 56 therebetween. Additionally, for the embodiment depicted, the outer nacelle 50 is supported relative to the turbomachine 16 by a plurality of circumferentially spaced outlet guide vanes 55.

During operation of the turbofan engine 10, a volume of air 58 enters the turbofan engine 10 through an associated inlet 60 of the outer nacelle 50 and/or fan section 14. As the volume of air 58 passes across the fan blades 40, a first portion of the air 58 as indicated by arrows 62 is directed or routed into the bypass airflow passage 56 and a second portion of the air 58 as indicated by arrow 64 is directed or routed into the core air flowpath 37. In the embodiment shown, an air splitter portion 80 divides these portions 62, 64 of the air 58. The ratio between an amount of airflow through the bypass airflow passage 56 (i.e., the first portion of air indicated by arrows 62) to an amount of airflow through the core air flowpath 37 (i.e., the second portion of air indicated by arrows 64) is known as a bypass ratio.

Referring still to FIG. 1, the compressed second portion of air indicated by arrows 64 from the compressor section mixes with fuel and is burned within the combustion section to provide combustion gases 66. The combustion gases 66 are routed from the combustion section 26, through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft 34, thus causing the HP shaft 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft 36, thus causing the LP shaft 36 to rotate, thereby supporting operation of the LP compressor 22 and/or rotation of the fan 38.

The combustion gases 66 are subsequently routed through the jet exhaust nozzle section 32 of the turbomachine 16 to provide propulsive thrust. Simultaneously, the pressure of the first portion of air indicated by arrows 62 is substantially increased as the first portion of air 62 is routed through the bypass airflow passage 56 before it is exhausted from a fan nozzle exhaust section 76 of the turbofan engine 10, also providing propulsive thrust. The HP turbine 28, the LP turbine 30, and the jet exhaust nozzle section 32 at least partially define a hot gas path 78 for routing the combustion gases 66 through the turbomachine 16.

Referring still to FIG. 1, the turbofan engine 10 additionally includes one or more graphene layers 100 coupled to, or integrated into, a portion of one of the fan 38, the turbomachine 16, and the outer nacelle 50, as described in greater detail herein. For example, the one or more graphene layers 100 may be coupled to, or integrated into, a portion of one of the outer nacelle 50 at the inlet 60, the fan blades 40, the hub 48, the air splitter portion 80, and the outlet guide vanes 55. It is contemplated that the one or more graphene layers 100 may be coupled to, or integrated into, one or all of these components. It is further contemplated that the one or more graphene layers 100 may be coupled to, or integrated into, other components of the turbofan engine 10.

Moreover, it should be appreciated that the exemplary turbofan engine 10 depicted in FIG. 1 is by way of example only, and that in other exemplary embodiments, the turbofan engine 10 may have any other suitable configuration. For example, in certain exemplary embodiments, the fan may not be a variable pitch fan, the engine may not include a reduction gearbox (e.g., power gear box 46) driving the fan, may include any other suitable number or arrangement of shafts, spools, compressors, turbines, etc. It is also contemplated that the turbofan engine 10 may be an open rotor engine or any other similar configuration.

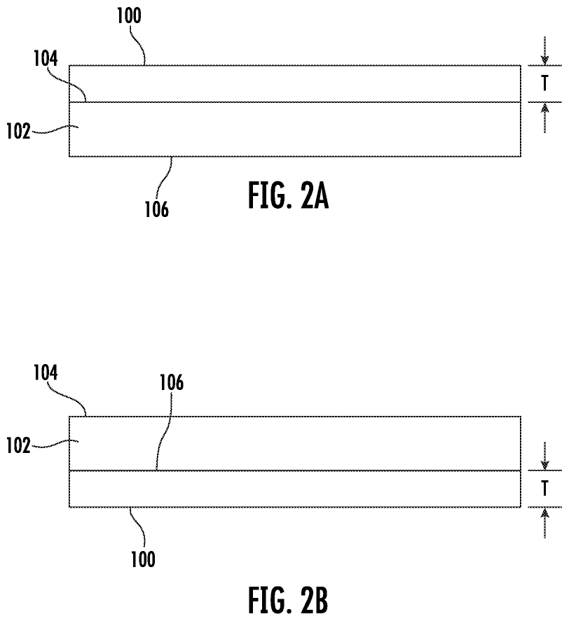

Referring now to FIG. 2A, a close-up, cross-sectional view of one or more graphene layers 100 coupled to, or integrated into, a portion of an engine component 102 of the exemplary turbofan engine 10 of FIG. 1 is provided.

In such an embodiment, the engine component 102 provided with one or more graphene layers 100 reduces ice buildup or ice formation on the engine component 102 of the turbofan engine 10 (FIG. 1). It is contemplated that graphene or any of its allotropes, e.g., carbon allotropes, carbon nanotubes, fullerene, or similar material, may be used in this manner to reduce ice buildup or ice formation on the engine component 102 of the turbofan engine 10 (FIG. 1).

Graphene is strong, flexible, impermeable to molecules, and highly electrically and thermally conductive. Furthermore, graphene combines the strength and light weight properties of the carbon network allotropes. Graphene also has a lower deterioration rate than conventional materials such as thermal barrier coatings. As such, graphene provides additional benefits including higher cycle operations.

Graphene has a melting temperature of about 5000 K (about 4727.degree. C.) and has remarkable properties withstanding flame. The conductivity of graphene is anisotropic, and graphene can be used as an insulating material. Graphene also has better impact resistance than Kevlar. Conventional ice resistance coatings that have a lower impact resistance cannot be applied to aero engines for these reasons. For example, engine inlet components are exposed to ingestion of foreign objects and airborne particles, for example, sand, dust, volcanic ash, ice crystals, snowflakes, super-cooled liquid droplets, hailstones, birds, insects, ice slabs, etc. Advantageously, the graphene layers of the present disclosure are mechanically strong enough to resist the impact of such foreign objects and particles.

The high conductivity of graphene and the possibility of adapting to any existing structure given the high melting point of graphene make the incorporation of one or more graphene layers particularly useful for an engine component 102 of the turbofan engine 10 (FIG. 1) in high temperature environments and to reduce ice buildup or ice formation on the engine component 102 of the turbofan engine 10 (FIG. 1). Each of the graphene layers 100 is monoatomic and therefore minimally intrusive and can be piled.

Referring still to FIG. 2A, in an exemplary embodiment, the one or more graphene layers 100 define a thickness T of approximately 3 mil to approximately 100 mil. In certain exemplary embodiments, the one or more graphene layers 100 comprise a thickness T of approximately 3 mil to approximately 75 mil. In certain exemplary embodiments, the one or more graphene layers 100 comprise a thickness T of approximately 3 mil to approximately 50 mil. In certain exemplary embodiments, the one or more graphene layers 100 comprise a thickness T of approximately 3 mil to approximately 25 mil.

In an exemplary embodiment, the one or more graphene layers 100 are coupled to an external surface 104 of the engine component 102. In exemplary embodiments, the external surface 104 of the engine component 102 is a surface that is exposed to ambient or a freeflow of air. Applying the one or more graphene layers 100 to an external surface 104 of the engine component 102 protects the engine component 102 from external atmospheric threats without adding excessive weight to the engine component 102. Furthermore, the one or more graphene layers 100 prevent erosion of the engine component 102.

Referring to FIG. 2B, a close-up, cross-sectional view of one or more graphene layers 100 coupled to, or integrated into, a portion of an engine component 102 of the exemplary turbofan engine 10 of FIG. 1 is provided. In another exemplary embodiment, the one or more graphene layers 100 are integrated into an interior surface 106 of the engine component 102.

Referring still to FIG. 2B, in an exemplary embodiment, the one or more graphene layers 100 define a thickness T of approximately 3 mil to approximately 100 mil. In certain exemplary embodiments, the one or more graphene layers 100 comprise a thickness T of approximately 3 mil to approximately 75 mil. In certain exemplary embodiments, the one or more graphene layers 100 comprise a thickness T of approximately 3 mil to approximately 50 mil. In certain exemplary embodiments, the one or more graphene layers 100 comprise a thickness T of approximately 3 mil to approximately 25 mil.

In an exemplary embodiment, the one or more graphene layers 100 are coupled to, or integrated into, an interior surface 106 of the engine component 102. In exemplary embodiments, the interior surface 106 of the engine component 102 is a surface that is not exposed to ambient or a freeflow of air. The interior surface 106 is opposite the external surface 104 of the engine component 102.

In one exemplary embodiment, an engine component 102 with one or more graphene layers 100 of the present disclosure is formed using precision casting, advanced machining, or other traditional manufacturing machines or methods. In one exemplary embodiment, an engine component 102 with one or more graphene layers 100 of the present disclosure is formed using additive manufacturing machines or methods. As described in detail below, exemplary embodiments of the formation of an engine component 102 with one or more graphene layers 100 involve the use of additive manufacturing machines or methods. As used herein, the terms “additively manufactured” or “additive manufacturing techniques or processes” refer generally to manufacturing processes wherein successive layers of material(s) are provided on each other to “build-up,” layer-by-layer, a three-dimensional component. The successive layers generally fuse together to form a monolithic component which may have a variety of integral sub-components.

Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or manufacturing technology. For example, embodiments of the present disclosure may use layer-additive processes, layer-subtractive processes, or hybrid processes.

Suitable additive manufacturing techniques in accordance with the present disclosure include, for example, Fused Deposition Modeling (FDM), Selective Laser Sintering (SLS), 3D printing such as by inkjets and laserjets, Sterolithography (SLA), Direct Selective Laser Sintering (DSLS), Electron Beam Sintering (EBS), Electron Beam Melting (EBM), Laser Engineered Net Shaping (LENS), Laser Net Shape Manufacturing (LNSM), Direct Metal Deposition (DMD), Digital Light Processing (DLP), Direct Selective Laser Melting (DSLM), Selective Laser Melting (SLM), Direct Metal Laser Melting (DMLM), and other known processes.

In addition to using a direct metal laser sintering (DMLS) or direct metal laser melting (DMLM) process where an energy source is used to selectively sinter or melt portions of a layer of powder, it should be appreciated that according to alternative embodiments, the additive manufacturing process may be a “binder jetting” process. In this regard, binder jetting involves successively depositing layers of additive powder in a similar manner as described above. However, instead of using an energy source to generate an energy beam to selectively melt or fuse the additive powders, binder jetting involves selectively depositing a liquid binding agent onto each layer of powder. The liquid binding agent may be, for example, a photo-curable polymer or another liquid bonding agent. Other suitable additive manufacturing methods and variants are intended to be within the scope of the present subject matter.

The additive manufacturing processes described herein may be used for forming an engine component 102 with one or more graphene layers 100 of the present disclosure using any suitable material. For example, the material may be plastic, metal, concrete, ceramic, polymer, epoxy, photopolymer resin, or any other suitable material that may be in solid, liquid, powder, sheet material, wire, or any other suitable form. More specifically, according to exemplary embodiments of the present subject matter, the additively manufactured components described herein may be formed in part, in whole, or in some combination of materials including but not limited to pure metals, nickel alloys, chrome alloys, titanium, titanium alloys, magnesium, magnesium alloys, aluminum, aluminum alloys, iron, iron alloys, stainless steel, and nickel or cobalt based superalloys (e.g., those available under the name Inconel® available from Special Metals Corporation). These materials are examples of materials suitable for use in the additive manufacturing processes described herein, and may be generally referred to as “additive materials.”

In addition, one skilled in the art will appreciate that a variety of materials and methods for bonding those materials may be used and are contemplated as within the scope of the present disclosure. As used herein, references to “fusing” may refer to any suitable process for creating a bonded layer of any of the above materials. For example, if an object is made from polymer, fusing may refer to creating a thermoset bond between polymer materials. If the object is epoxy, the bond may be formed by a crosslinking process. If the material is ceramic, the bond may be formed by a sintering process. If the material is powdered metal, the bond may be formed by a melting or sintering process. One skilled in the art will appreciate that other methods of fusing materials to make a component by additive manufacturing are possible, and the presently disclosed subject matter may be practiced with those methods.

In addition, the additive manufacturing process disclosed herein allows an integral engine component 102 with one or more graphene layers 100 to be formed from multiple materials. Thus, the components described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein may be constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

An exemplary additive manufacturing process will now be described. Additive manufacturing processes fabricate components using three-dimensional (3D) information, for example a three-dimensional computer model, of an engine component 102 with one or more graphene layers 100 of the present disclosure. Accordingly, a three-dimensional design model of the component may be defined prior to manufacturing. In this regard, a model or prototype of the component may be scanned to determine the three-dimensional information of the component. As another example, a model of an engine component 102 with one or more graphene layers 100 of the present disclosure may be constructed using a suitable computer aided design (CAD) program to define the three-dimensional design model of the component.

The design model may include 3D numeric coordinates of the entire configuration of an engine component 102 with one or more graphene layers 100 of the present disclosure including both external and internal surfaces of the component. For example, the design model may define the body, the surface, and/or internal passageways such as openings, support structures, etc. In one exemplary embodiment, the three-dimensional design model is converted into a plurality of slices or segments, e.g., along a central (e.g., vertical) axis of the component or any other suitable axis. Each slice may define a thin cross section of the component for a predetermined height of the slice. The plurality of successive cross-sectional slices together form the 3D component. The component is then “built-up” slice-by-slice, or layer-by-layer, until finished.

In this manner, an engine component 102 with one or more graphene layers 100 of the present disclosure described herein may be fabricated using the additive process, or more specifically each layer is successively formed, e.g., by fusing or polymerizing a plastic using laser energy or heat or by sintering or melting metal powder. For example, a particular type of additive manufacturing process may use an energy beam, for example, an electron beam or electromagnetic radiation such as a laser beam, to sinter or melt a powder material. Any suitable laser and laser parameters may be used, including considerations with respect to power, laser beam spot size, and scanning velocity. The build material may be formed by any suitable powder or material selected for enhanced strength, durability, and useful life, particularly at high temperatures.

Each successive layer may be, for example, between about 10 μm and 200 μm, although the thickness may be selected based on any number of parameters and may be any suitable size according to alternative embodiments. Therefore, utilizing the additive formation methods described above, the components described herein may have cross sections as thin as one thickness of an associated powder layer, e.g., μm, utilized during the additive formation process.

In addition, utilizing an additive process, the surface finish and features of an engine component 102 with one or more graphene layers 100 of the present disclosure may vary as need depending on the application. For example, the surface finish may be adjusted (e.g., made smoother or rougher) by selecting appropriate laser scan parameters (e.g., laser power, scan speed, laser focal spot size, etc.) during the additive process, especially in the periphery of a cross-sectional layer which corresponds to the part surface. For example, a rougher finish may be achieved by increasing laser scan speed or decreasing the size of the melt pool formed, and a smoother finish may be achieved by decreasing laser scan speed or increasing the size of the melt pool formed. The scanning pattern and/or laser power can also be changed to change the surface finish in a selected area.

After fabrication of an engine component 102 with one or more graphene layers 100 of the present disclosure is complete, various post-processing procedures may be applied to the component. For example, post processing procedures may include removal of excess powder by, for example, blowing or vacuuming. Other post processing procedures may include a stress relief process. Additionally, thermal, mechanical, and/or chemical post processing procedures can be used to finish the part to achieve a desired strength, surface finish, and other component properties or features.

While the present disclosure is not limited to the use of additive manufacturing to form an engine component 102 with one or more graphene layers 100 of the present disclosure generally, additive manufacturing does provide a variety of manufacturing advantages, including ease of manufacturing, reduced cost, greater accuracy, etc.

Also, the additive manufacturing methods described above enable much more complex and intricate shapes and contours of an engine component 102 with one or more graphene layers 100 described herein to be formed with a very high level of precision. For example, such components may include thin additively manufactured layers, cross sectional features, and component contours. In addition, the additive manufacturing process enables the manufacture of an integral engine component 102 with one or more graphene layers 100 having different materials such that different portions of the component may exhibit different performance characteristics. The successive, additive nature of the manufacturing process enables the construction of these novel features. As a result, an engine component 102 with one or more graphene layers 100 of the present disclosure formed using the methods described herein may exhibit improved performance and reliability.

It is contemplated that the engine component 102 provided with one or more graphene layers 100 to reduce ice buildup or ice formation on the engine component 102 of the turbofan engine 10 (FIG. 1) may include any component of the turbofan engine 10 (FIG. 1).

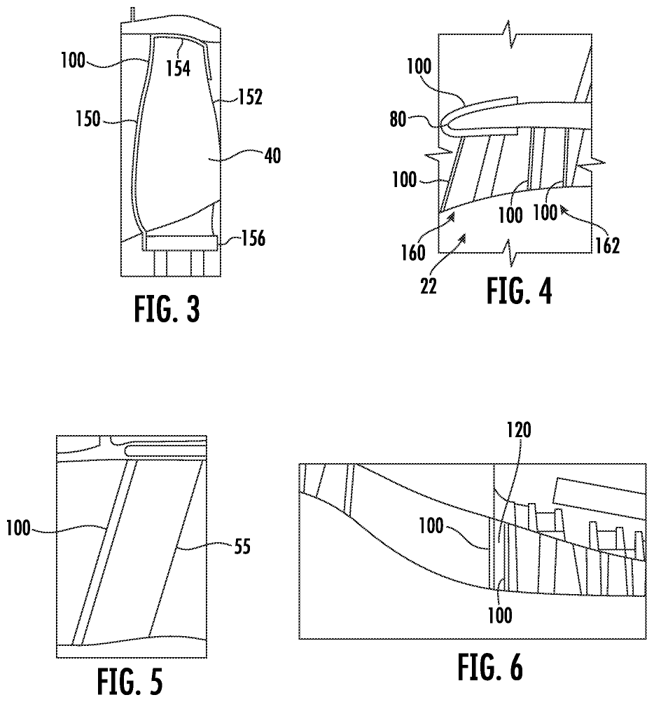

For example, in an exemplary embodiment, referring now to FIG. 3, a close-up, cross-sectional view of a portion of a fan blade 40 provided with one or more graphene layers 100 is provided. The fan blade 40 includes a leading edge 150, a trailing edge 152, a tip 154, and a root section 156.

In the embodiment depicted, the one or more graphene layers 100 are provided over the leading edge 150 of the fan blade 40 from the root section 156 to the tip 154. Furthermore, the one or more graphene layers 100 are provided over the tip 154 and extend to cover a portion of the trailing edge 152. It is also contemplated that, in other exemplary embodiments, the one or more graphene layers 100 are provided over the trailing edge 152 of the fan blade 40 from the root section 156 to the tip 154.

In another exemplary embodiment, referring now to FIG. 4, a close-up, cross-sectional view of a portion of an air splitter portion 80 provided with one or more graphene layers 100 is provided. Also shown is a portion of the LP compressor 22 which includes stator components 160 and rotor components 162.

In the embodiment depicted, the one or more graphene layers 100 are provided over the air splitter portion 80. Furthermore, the one or more graphene layers 100 are provided over leading edges of the stator components 160 and rotor components 162.

In another exemplary embodiment, referring now to FIG. 5, a close-up, cross-sectional view of a portion of an outlet guide vane 55 provided with one or more graphene layers 100 is provided. For example, the one or more graphene layers 100 are provided over the leading edge of the outlet guide vane 55.

In another exemplary embodiment, referring now to FIG. 6, a close-up, cross-sectional view of a portion of an inlet guide vane 120 provided with one or more graphene layers 100 is provided. For example, the one or more graphene layers 100 are provided over the leading edge of the inlet guide vane 120.

It is also contemplated that one or more graphene layers 100 can be provided over other engine inlet components, e.g., pressure sensors, temperature sensors, pressure probes, temperature probes, and other similar engine components.

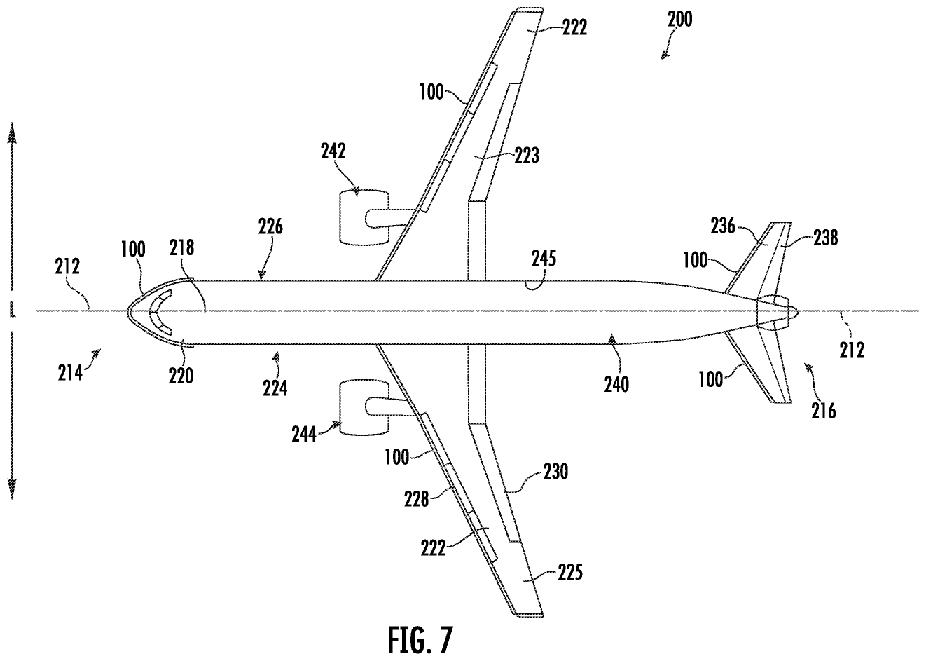

In another exemplary embodiment, referring now to FIG. 7, a top view of an exemplary aircraft 200 of the present disclosure is provided. FIG. 7 provides an aircraft 200 that defines a longitudinal centerline 212 that extends therethrough, a lateral direction L, a forward end 214, and an aft end 216. Moreover, the aircraft 200 defines a mean line 218 extending between the forward end 214 and aft end 216 of the aircraft 200. As used herein, the “mean line” refers to a midpoint line extending along a length of the aircraft 200, not taking into account the appendages of the aircraft 200 (such as the wing assembly 222 discussed below).

Moreover, the aircraft 200 includes a fuselage 220, extending longitudinally from the forward end 214 of the aircraft 200 towards the aft end 216 of the aircraft 200, and a wing assembly 222. In an exemplary embodiment of the present disclosure, the wing assembly 222 includes a first primary wing 223 and a second primary wing 225. For example, the first primary wing 223 extends laterally outwardly with respect to the longitudinal centerline 212 from a first or starboard side 226 of the fuselage 220 and the second primary wing 225 extends laterally outwardly with respect to the longitudinal centerline 212 from a second or port side 224 of the fuselage 220. Each of the primary wings 223, 225 for the exemplary embodiment depicted may include one or more leading edge flaps 228 and one or more trailing edge flaps 230. The aircraft 200 further includes a vertical stabilizer having a rudder flap for yaw control, and a pair of horizontal stabilizers 236, each having an elevator flap 238 for pitch control. The fuselage 220 additionally includes an outer surface 240.

The exemplary aircraft 200 of FIG. 7 also includes a propulsion system. In an exemplary embodiment, the exemplary propulsion system includes a plurality of aircraft engines, at least one of which is mounted to the primary wings 223, 225. For example, the plurality of aircraft engines includes a first aircraft engine 242 mounted to a first primary wing 223 and a second aircraft engine 244 mounted to a second primary wing 225. In at least certain exemplary embodiments, the aircraft engines 242, 244 may be configured as turbofan jet engines suspended beneath the primary wings 223, 225 in an under-wing configuration. Alternatively, however, in other exemplary embodiments any other suitable aircraft engine may be provided. For example, in other exemplary embodiments the first and/or second aircraft engines 242, 244 may alternatively be configured as turbojet engines, turboshaft engines, turboprop engines, etc.

In such an embodiment, the aircraft 200 is provided with one or more graphene layers 100 that reduce ice buildup or ice formation on the aircraft 200. In an exemplary embodiment, it is contemplated that the one or more graphene layers 100 to reduce ice buildup or ice formation on the aircraft 200 may be provided at the forward end 214, e.g., a nose portion, of the fuselage 220. In other exemplary embodiments, it is contemplated that the one or more graphene layers 100 to reduce ice buildup or ice formation on the aircraft 200 may be provided at any portion of the fuselage 220.

In other exemplary embodiments, the one or more graphene layers 100 can be applied to the leading edges of the first primary wing 223, the second primary wing 225, and the horizontal stabilizer 236. It is also contemplated that the one or more graphene layers 100 can be applied to other components of the aircraft 200 such as vertical stabilizers, tail fin, aircraft air data sensors, probes, and other components.

In an exemplary embodiment, the one or more graphene layers 100 are coupled to an outer surface 240 of the fuselage 220. In another exemplary embodiment, the one or more graphene layers 100 are integrated into an interior surface 245 of the fuselage 220.

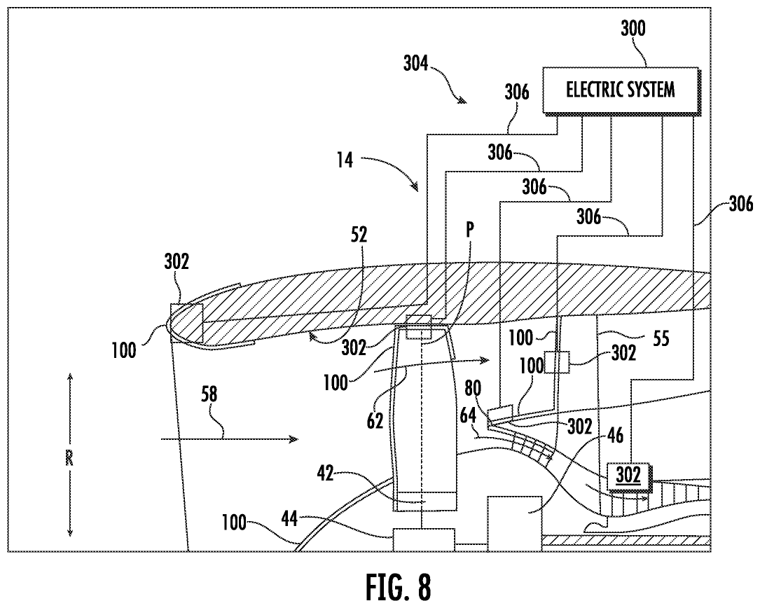

Referring now to FIG. 8, a cross-sectional view of a fan section 14 and a turbomachine 16 of a turbofan engine 10 in accordance with another exemplary embodiment of the present disclosure is provided. The exemplary turbofan engine 10 of FIG. 8 may be configured in a similar manner as the exemplary engine of FIG. 1 described above. In the exemplary embodiment depicted, components of the turbofan engine 10 are provided with one or more graphene layers 100 to reduce ice buildup or ice formation on the components of the turbofan engine 10.

For example, in an exemplary embodiment, a portion of a fan blade 40 is provided with one or more graphene layers 100. In another exemplary embodiment, a portion of an air splitter portion 80 is provided with one or more graphene layers 100. In another exemplary embodiment, a portion of an outlet guide vane 55 is provided with one or more graphene layers 100. In another exemplary embodiment, a portion of an inlet guide vane 120 provided with one or more graphene layers 100.

In an exemplary embodiment, the turbofan engine 10 also includes an electrical system 300 having electrical heating elements 302, an electrical supply assembly 304, and electrical supply cables 306. In an exemplary embodiment, the electrical heating elements 302 are disposed in thermal communication with the one or more graphene layers 100. For example, an electrical heating element 302 is disposed in thermal communication with the one or more graphene layers 100 at each of the fan blade 40, the air splitter portion 80, the outlet guide vane 55, and the inlet guide vane 120.

In an exemplary embodiment, the electrical supply assembly 304 includes electrical supply cables 306 that are in electrical communication with the electrical heating elements 302. In this manner, the electrical supply cables 306 of the electrical system 300 provide power to the electrical heating elements 302 to heat the one or more graphene layers 100 at each of the fan blade 40, the air splitter portion 80, the outlet guide vane 55, and the inlet guide vane 120. The electrical system 300 operates as a further means for reducing ice buildup or ice formation at the components of the turbofan engine 10.

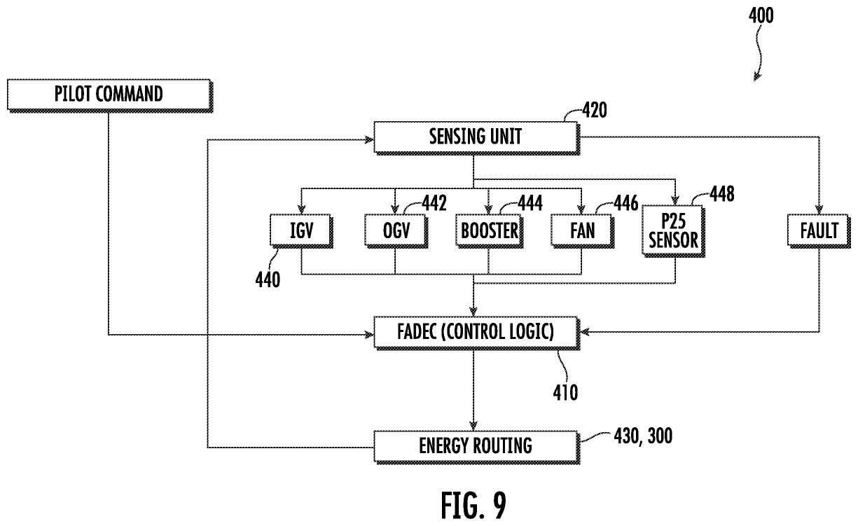

FIG. 9 provides a block diagram of an exemplary control system 400 for controlling a turbofan engine 10 (FIG. 1) in accordance with exemplary embodiments of the present disclosure.

Referring to FIG. 9, a control system 400 of the present disclosure may be in communication with the electrical system 300 (FIG. 8) of the turbofan engine 10. For example, the control system 400 may be used to determine when to start the electrical system 300 (FIG. 8) of the present disclosure to provide power to the electrical heating elements 302 (FIG. 8).

In some embodiments, all of the components of the control system 400 are onboard the turbofan engine 10. In other embodiments, some of the components of the control system 400 are onboard the turbofan engine 10 and some are offboard the turbofan engine 10. For instance, some of the offboard components can be mounted to a wing, fuselage, or other suitable structure of an aerial vehicle to which the turbofan engine 10 is mounted.

Referring to FIG. 9, the control system 400 includes a controller 410, a sensing unit 420, and a power source 430. In an exemplary embodiment, the control system 400 is in communication with an inlet guide vane 440, an outlet guide vane 442, a booster 444, a fan 446, and/or a sensor 448. In an exemplary embodiment, the power source 430 is the electrical system 300. It is contemplated that the sensor 448 can include pressure and temperature sensors.

In an exemplary embodiment, the sensing unit 420 may include sensors at the components of the turbofan engine 10, e.g., an inlet guide vane 440, an outlet guide vane 442, a booster 444, a fan 446, and/or a sensor 448 that include the electrical heating elements 302 to heat the one or more graphene layers 100.

The sensing unit 420 of the control system 400 monitors conditions of the components of the turbofan engine 10. When the sensing unit 420 receives an input indicating a change in a condition of one of the components of the turbofan engine 10, the controller 410 causes the electrical supply assembly 304 of the electrical system 300 to provide power to the electrical heating elements 302. It is contemplated that the conditions of the components of the turbofan engine 10 that are monitored by the sensing unit 420 include temperature, pressure, and/or other information indicative of an icing condition and/or ice formation on a component of the turbofan engine 10.

In an exemplary embodiment, the turbofan engine 10 includes a computing system. Particularly, for this embodiment, the turbofan engine 10 includes a computing system having one or more computing devices, including a controller 410 configured to control the turbofan engine 10, and in this embodiment, the power source 430 and other components of the control system 400. The controller 410 can include one or more processor(s) and associated memory device(s) configured to perform a variety of computer-implemented functions and/or instructions (e.g., performing the methods, steps, calculations and the like and storing relevant data as disclosed herein). The instructions, when executed by the one or more processors, can cause the one or more processor(s) to perform operations, such as causing the electrical supply assembly 304 of the electrical system 300 to provide power to the electrical heating elements 302 upon receiving an input indicating a change in condition of one of the components of the turbofan engine 10.

Additionally, the controller 410 can include a communications module to facilitate communications between the controller 410 and various components of the aerial vehicle and other electrical components of the turbofan engine 10. The communications module can include a sensor interface (e.g., one or more analog-to-digital converters) to permit signals transmitted from the one or more sensors to be converted into signals that can be understood and processed by the one or more processor(s). It should be appreciated that the sensors can be communicatively coupled to the communications module using any suitable means. For example, the sensors can be coupled to the sensor interface via a wired connection. However, in other embodiments, the sensors can be coupled to the sensor interface via a wireless connection, such as by using any suitable wireless communications protocol. As such, the processor(s) can be configured to receive one or more signals or outputs from the sensors, such as one or more operating conditions/parameters.

As used herein, the term “processor” refers not only to integrated circuits referred to in the art as being included in a computing device, but also refers to a controller, a microcontroller, a microcomputer, a programmable logic controller (PLC), an application specific integrated circuit, and other programmable circuits. The one or more processors can also be configured to complete the required computations needed to execute advanced algorithms. Additionally, the memory device(s) can generally include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) can generally be configured to store suitable computer-readable instructions that, when implemented by the processor(s), configure the controllers 410 to perform the various functions described herein. The controller 410 can be configured in substantially the same manner as the exemplary computing device of the computing system 500 described below with reference to FIG. 11 (and may be configured to perform one or more of the functions of the exemplary method (450) described herein).

The controller 410 may be a system of controllers or a single controller. The controller 410 may be a controller dedicated to control of the power source 430, the electrical system 300, and associated electrical components or can be an engine controller configured to control the turbofan engine 10 as well as the control system 400, and its associated electrical components. The controller 410 can be, for example, an Electronic Engine Controller (EEC) or an Electronic Control Unit (ECU) of a Full Authority Digital Engine Control (FADEC) system.

The control system 400 can include one or more power management electronics or electrical control devices, such as inverters, converters, rectifiers, devices operable to control the flow of electrical current, etc. For instance, one or more of the control devices can be operable to condition and/or convert electrical power (e.g., from AC to DC or vice versa). Further, one or more of the control devices can be operable to control the electrical power provided to the electrical system 300 by the power source 430. Although, the control devices may be separate from the power source 430 and the controller 410, it will be appreciated that one, some, or all of control devices can be located onboard the power source 430 and/or the controller 410.

As discussed, the turbofan engine 10 may also include one or more sensors for sensing and/or monitoring various engine operating conditions and/or parameters during operation. For instance, one or more sensors can be positioned at the inlet guide vane 440, one or more sensors can be positioned at the outlet guide vane 442, one or more sensors can be positioned at the booster 444, and one or more sensors can be positioned at the fan 446, among other possible locations. The sensors of the sensing unit 420 can sense or measure various engine conditions, e.g., pressures and temperatures, and one or more signals may be routed from the one or more sensors to the controller 410 for processing. Accordingly, the controller 410 is communicatively coupled with the one or more sensors, e.g., via a suitable wired or wireless communication link. It will be appreciated that the turbofan engine 10 can include other sensors at other suitable stations along the core air flowpath.

In an exemplary embodiment, the one or more sensors of the sensing unit 420 may monitor a temperature of the turbofan engine 10 and the controller 410 may be configured to provide power to the electrical system 300 once certain predetermined conditions of the components of the turbofan engine 10 have been reached. In exemplary embodiments, the one or more sensors of the sensing unit 420 may include resistance temperature detectors.

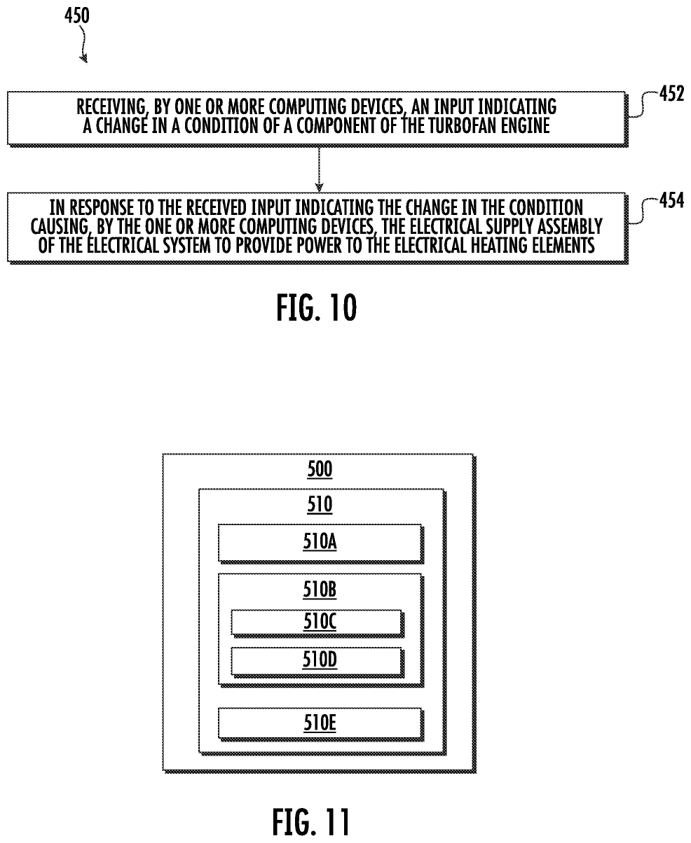

FIG. 10 provides a flow diagram of an exemplary method (450) of monitoring conditions of components of the turbofan engine 10 and causing the electrical system 300 to provide power to the electrical heating elements 302 in accordance with exemplary embodiments of the present disclosure. For instance, the exemplary method (450) may be utilized for operating the turbofan engine 10 described herein. It should be appreciated that the method (450) is discussed herein only to describe exemplary aspects of the present subject matter and is not intended to be limiting.

At (452), the method (450) includes receiving, by one or more computing devices, an input indicating a change in condition of a component of the turbofan engine 10. For instance, the controller 410 can receive the input in response to when a condition, e.g., a temperature or a pressure, of a component of the turbofan engine is reached.

At (454), in response to the received input indicating the change in condition of a component of the turbofan engine 10, the method (450) includes causing, by the one or more computing devices, the electrical supply assembly 304 of the electrical system 300 to provide power to the electrical heating elements 302.

FIG. 11 provides an example computing system 500 according to example embodiments of the present disclosure. The computing systems (e.g., the controller 410) described herein may include various components and perform various functions of the computing system 500 described below, for example.

As shown in FIG. 11, the computing system 500 can include one or more computing device(s) 510. The computing device(s) 510 can include one or more processor(s) 510A and one or more memory device(s) 510B. The one or more processor(s) 510A can include any suitable processing device, such as a microprocessor, microcontroller, integrated circuit, logic device, and/or other suitable processing device. The one or more memory device(s) 510B can include one or more computer-readable media, including, but not limited to, non-transitory computer-readable media, RAM, ROM, hard drives, flash drives, and/or other memory devices.

The one or more memory device(s) 510B can store information accessible by the one or more processor(s) 510A, including computer-readable instructions 510C that can be executed by the one or more processor(s) 510A. The instructions 510C can be any set of instructions that when executed by the one or more processor(s) 510A, cause the one or more processor(s) 510A to perform operations. In some embodiments, the instructions 510C can be executed by the one or more processor(s) 510A to cause the one or more processor(s) 510A to perform operations, such as any of the operations and functions for which the computing system 500 and/or the computing device(s) 510 are configured, operations for electrically assisting a turbomachine during transient operation (e.g., method (450)), and/or any other operations or functions of the one or more computing device(s) 510. Accordingly, the method (450) may be a computer-implemented method, such that each of the steps of the exemplary method (450) are performed by one or more computing devices, such as the exemplary computing device 510 of the computing system 500. The instructions 510C can be software written in any suitable programming language or can be implemented in hardware. Additionally, and/or alternatively, the instructions 510C can be executed in logically and/or virtually separate threads on processor(s) 510A. The memory device(s) 510B can further store data 510D that can be accessed by the processor(s) 510A. For example, the data 510D can include models, databases, etc.

The computing device(s) 510 can also include a network interface 510E used to communicate, for example, with the other components of system 500 (e.g., via a network). The network interface 510E can include any suitable components for interfacing with one or more network(s), including for example, transmitters, receivers, ports, controllers, antennas, and/or other suitable components. One or more external devices, such as electrical control device(s), can be configured to receive one or more commands from the computing device(s) 510 or provide one or more commands to the computing device(s) 510.

A control system 400 of the present disclosure does not require a change to the mechanical hardware of an engine and facilities simple retrofit with existing engines.

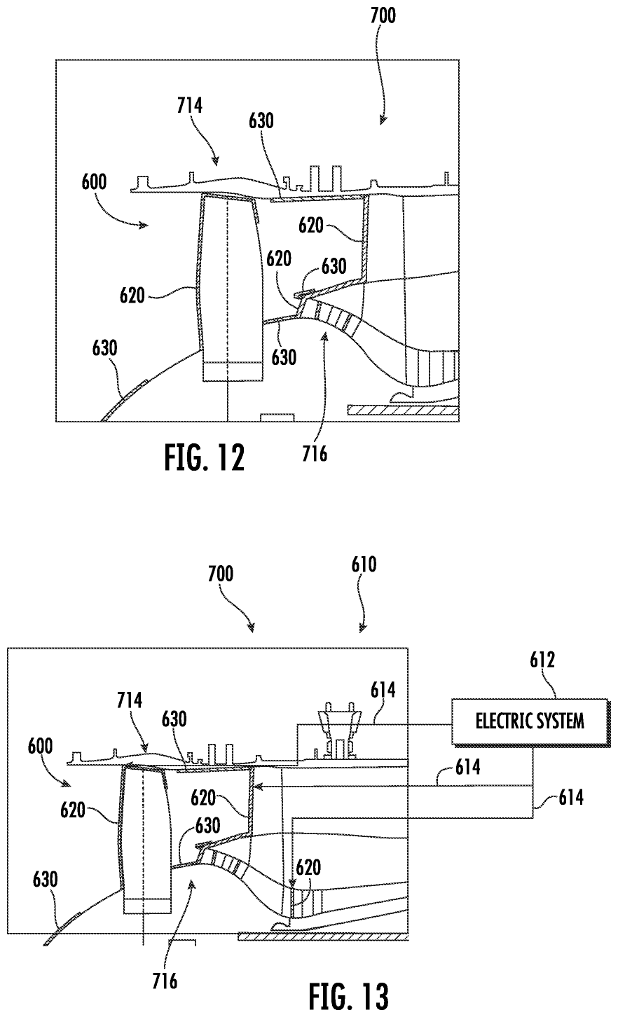

Referring now generally to FIGS. 12 through 19, in other exemplary embodiments of the present disclosure, an anti-icing system configured to reduce ice buildup or ice formation on components of an engine will now be described. In other exemplary embodiments of the present disclosure, an anti-icing system 600 includes an electrical supply assembly 610, a first anti-icing component 620 in contact with the electrical supply assembly 610, and a second anti-icing component 630 that is not in contact with the electrical supply assembly 610. The anti-icing system 600 operates as a means for reducing ice buildup or ice formation at desired components of a turbofan engine.

Inclusion of both a first anti-icing component 620 that is in contact with the electrical supply assembly 610 and a second anti-icing component 630 that is not in contact with the electrical supply assembly 610 provides an anti-icing or de-icing mechanism that may prevent the buildup and shedding of pieces of ice into the engine during, e.g., adverse weather conditions, potentially resulting in safer operation of the gas turbine engine, while also reducing the weight of the anti-icing system 600.

Referring now to FIGS. 12 and 13, cross-sectional views of a fan section 714 and a turbomachine 716 of a turbofan engine 700 in accordance with another exemplary embodiment of the present disclosure is provided. The exemplary turbofan engine 700 of FIG. 12 may be configured in a similar manner as the exemplary engine of FIG. 1 described above. In the exemplary embodiment depicted, an anti-icing system 600 includes an electrical supply assembly 610, a first anti-icing component 620 in contact with the electrical supply assembly 610, and a second anti-icing component 630 that is not in contact with the electrical supply assembly 610.

Referring still to FIGS. 12 and 13, in an exemplary embodiment, the electrical supply assembly 610 is part of an electrical system 612 including electrical supply cables 614. The electrical supply cables 614 are disposed in electrical communication, i.e., contact, with the first anti-icing component 620. In this manner, the electrical supply cables 614 of the electrical system 612 provide power to the first anti-icing component 620 to heat the first anti-icing component 620 at desired locations around the fan section 714 and the turbomachine 716 of the turbofan engine 700.

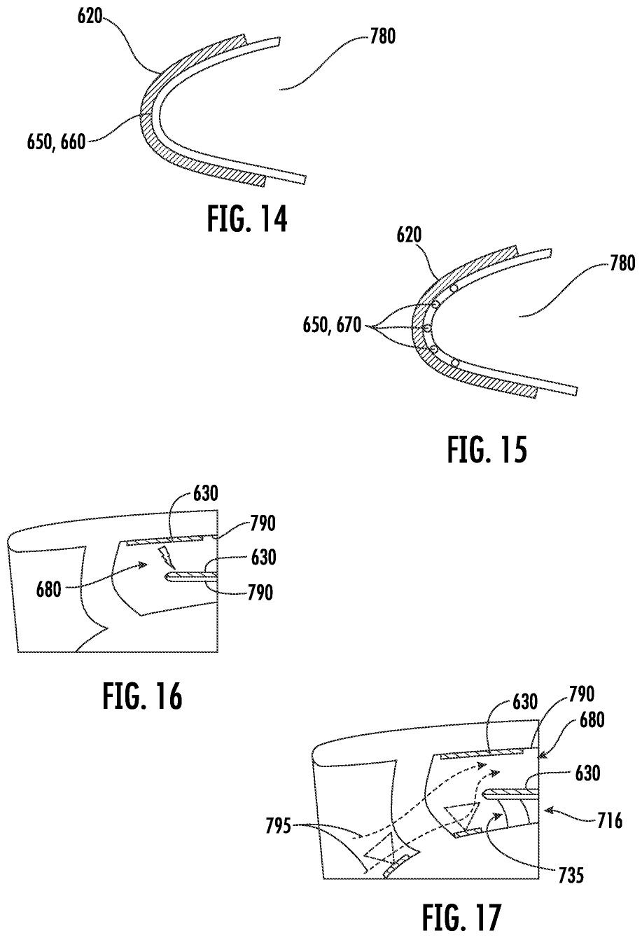

Referring now to FIGS. 14 and 15, cross-sectional views of a first anti-icing component 620 that is coupled to a desired first engine component 780 of a turbofan engine 700 in accordance with exemplary embodiments of the present disclosure are provided.

In exemplary embodiments, the first anti-icing component 620 is provided to a desired first engine component 780 of the turbofan engine 700. It is contemplated that a plurality of first anti-icing components 620 may be provided to desired first engine components 780 of the turbofan engine 700. The first anti-icing component 620 in contact with the electrical supply assembly 610 may include a variety of conductive materials 650 that are provided electrical power from the electrical supply cables 614 of the electrical system 612 to heat the conductive materials 650 and reduce ice buildup or ice formation at the first engine component 780.

Referring to FIG. 14, in an exemplary embodiment, the first anti-icing component 620 in contact with the electrical supply assembly 610 includes a graphene coating 660. In this manner, the graphene coating 660 is coupled to a desired first engine component 780 of the turbofan engine 700 and receives electrical power from the electrical supply cables 614 of the electrical system 612 to heat the graphene coating 660 and reduce ice buildup or ice formation at the first engine component 780.

Referring to FIG. 15, in another exemplary embodiment, the first anti-icing component 620 in contact with the electrical supply assembly 610 includes a plurality of piezoelectric actuators 670. In this manner, the piezoelectric actuators 670 are coupled to a desired first engine component 780 of the turbofan engine 700 and receives electrical power from the electrical supply cables 614 of the electrical system 612 to heat the piezoelectric actuators 670 and reduce ice buildup or ice formation at the first engine component 780. In an exemplary embodiment, the plurality of piezoelectric actuators 670 are positioned within a flexible outer covering 785 of a desired first engine component 780 of the turbofan engine 700.

It is contemplated that the first anti-icing component 620 in contact with the electrical supply assembly 610 may be provided to the following first engine components 780 of the turbofan engine 700, e.g., a portion of a fan blade, a portion of an outlet guide vane, a portion of an inlet guide vane, and/or a portion of an air splitter portion.

Referring now to FIGS. 16 and 17, cross-sectional views of a second anti-icing component 630 that is coupled to a desired second engine component 790 of a turbofan engine 700 in accordance with exemplary embodiments of the present disclosure are provided.

In exemplary embodiments, the second anti-icing component 630 is provided to a desired second engine component 790 of the turbofan engine 700. It is contemplated that a plurality of second anti-icing components 630 may be provided to desired second engine components 790 of the turbofan engine 700. The second anti-icing component 630 is not in contact with the electrical supply assembly 610. In this manner, the second anti-icing component 630 reduces the weight of the anti-icing system 600.

Referring to FIG. 16, in an exemplary embodiment, the second anti-icing component 630 not in contact with the electrical supply assembly 610 includes an electromagnetic system 680. In this manner, electromagnetic radiation produced by the electromagnetic system 680 heats the second engine component 790 and reduces ice buildup or ice formation at the second engine component 790.

Referring to FIG. 17, in another exemplary embodiment, the electromagnetic radiation produced by the electromagnetic system 680 also is able to deflect foreign objects 795 away from a core inlet 735 of the turbomachine 716.

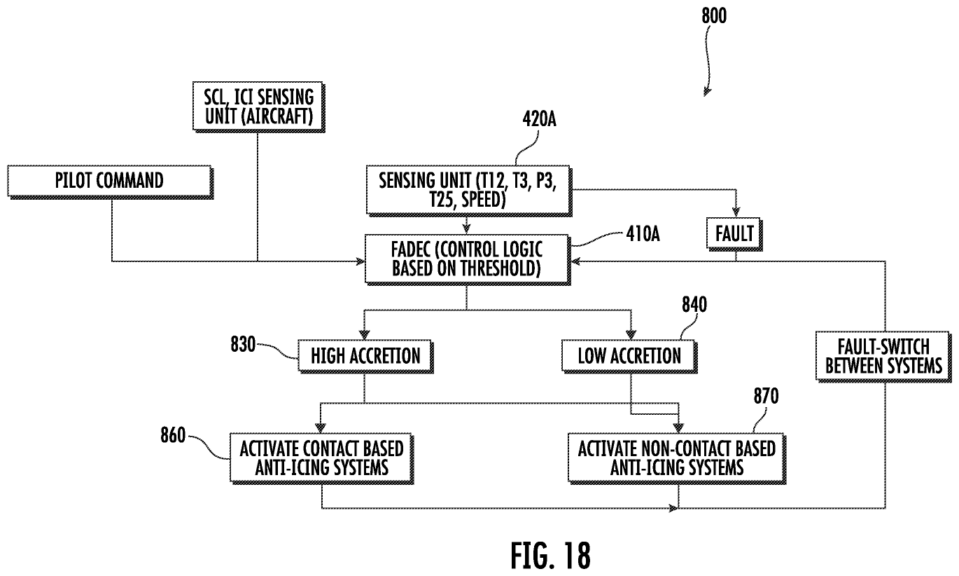

FIG. 18 provides a block diagram of an exemplary control system 800 for controlling a turbofan engine 700 (FIGS. 12 and 13) and an anti-icing system 600 (FIGS. 12-17) in accordance with exemplary embodiments of the present disclosure. An exemplary control system 800 depicted in FIG. 18 may be configured in substantially the same manner as the exemplary control system 400 described above with reference to FIGS. 9 and 11. The embodiment illustrated in FIG. 18 includes similar components to the embodiment illustrated in FIG. 9, and the similar components are denoted by a reference number followed by the letter A. For the sake of brevity, these similar components of control system 800 (FIG. 18) will not all be discussed in conjunction with the embodiment illustrated in FIG. 18.

Referring to FIG. 18, the control system 800 of the present disclosure may be in communication with the anti-icing system 600 (FIGS. 12-17), e.g., the first anti-icing component 620 (FIGS. 12 and 13) that is in contact with the electrical supply assembly 610 and the second anti-icing component 630 (FIGS. 12 and 13) that is not in contact with the electrical supply assembly 610. For example, the control system 800 may be used to determine when to activate the first anti-icing component 620 (FIGS. 12 and 13) that is in contact with the electrical supply assembly 610 or when to activate the second anti-icing component 630 (FIGS. 12 and 13) that is not in contact with the electrical supply assembly 610.

In an exemplary embodiment, the sensing unit 420A may include sensors located at desired engine components 780, 790 of the turbofan engine 700 (FIGS. 12 and 13). The sensing unit 420A of the control system 800 monitors conditions, e.g., a high accretion condition 830 and a low accretion condition 840, of the components 780, 790 of the turbofan engine 700 (FIGS. 12 and 13). Generally, when the sensing unit 420A receives an input indicating a change in a condition, e.g., a high accretion condition 830 and a low accretion condition 840, of one of the components 780, 790 of the turbofan engine 700, the controller 410A may make a determination of one or more conditions indicative of an icing condition or a potential icing condition, and if (A) a high accretion condition 830 is detected, then at activate contact based anti-icing system control 860 activate an electrical supply assembly 610 of the anti-icing system 600 (FIGS. 12 and 13) to start the electrical system 612 (FIG. 13) of the present disclosure to provide power to the first anti-icing components 620 (FIGS. 12 and 13) and if (B) a low accretion condition 840 is detected, then at activate non-contact based anti-icing system control 870 activate an electromagnetic system 680 of the second anti-icing component 630 (FIGS. 12, 13, and 16) to produce electromagnetic radiation to heat the second engine component 790 and reduce ice buildup or ice formation at the second engine component 790.

It is contemplated that the conditions, e.g., a high accretion condition 830 and a low accretion condition 840, of the components 780, 790 of the turbofan engine 700 that are monitored by the sensing unit 420A include temperature, pressure, and/or other information indicative of an icing condition and/or ice formation on a component 780, 790 of the turbofan engine 700.

Advantageously, as described herein, inclusion of both a first anti-icing component 620 that is in contact with the electrical supply assembly 610 and a second anti-icing component 630 that is not in contact with the electrical supply assembly 610 provides an anti-icing or de-icing mechanism that may prevent the buildup and shedding of pieces of ice into the engine during, e.g., adverse weather conditions, potentially resulting in safer operation of the gas turbine engine, while also reducing the weight of the anti-icing system 600. Furthermore, the control system 800 of the present disclosure leverages the available electricity from the turbofan engine 700 by utilizing a controlled combination of contact and non-contact based anti-icing components.

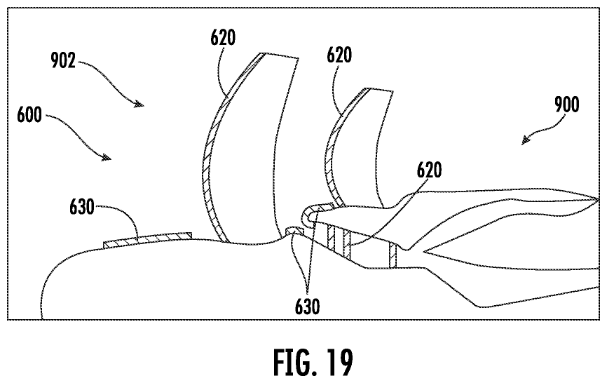

Referring now to FIG. 19, a schematic cross-sectional view of a gas turbine engine 900 is provided according to another exemplary embodiment of the present disclosure. Particularly, FIG. 19 provides an engine having a rotor assembly with a single stage of unducted rotor blades. In such a manner, the rotor assembly may be referred to herein as an “unducted fan,” or the entire engine 900 may be referred to as an “unducted engine,” or an engine having an open rotor propulsion system 902.

It is also contemplated that an anti-icing system 600 (FIGS. 12-18) of the present disclosure that includes an electrical supply assembly 610, a first anti-icing component 620 in contact with the electrical supply assembly 610, and a second anti-icing component 630 that is not in contact with the electrical supply assembly 610 may also be compatible with such an engine 900 having an open rotor propulsion system 902. The anti-icing system 600 operates as a means for reducing ice buildup or ice formation at desired components of a turbofan engine as described in detail herein.

It is contemplated that the turbomachines and methods of the present disclosure may be implemented on an aircraft, helicopter, automobile, boat, submarine, train, unmanned aerial vehicle or drone and/or on any other suitable vehicle. While the present disclosure is described herein with reference to an aircraft implementation, this is intended only to serve as an example and not to be limiting. One of ordinary skill in the art would understand that the turbomachines and methods of the present disclosure may be implemented on other vehicles without deviating from the scope of the present disclosure.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Although specific features of various embodiments may be shown in some drawings and not in others, this is for convenience only. In accordance with the principles of the present disclosure, any feature of a drawing may be referenced and/or claimed in combination with any feature of any other drawing.

Further aspects of the disclosure are provided by the subject matter of the following clauses:

A gas turbine engine comprising: a fan comprising a plurality of fan blades; a turbomachine operably coupled to the fan for driving the fan, the turbomachine comprising a compressor section, a combustion section, and a turbine section in serial flow order and together defining a core air flowpath; and one or more graphene layers coupled to, or integrated into, a portion of the gas turbine engine, wherein the one or more graphene layers are configured to reduce ice buildup or ice formation.

The gas turbine engine of any preceding clause, further comprising a nacelle surrounding and at least partially enclosing the fan.

The gas turbine engine of any preceding clause, wherein the one or more graphene layers are coupled to an external surface of one of the fan, the turbomachine, and the nacelle, wherein the external surface is exposed to a freeflow of air.

The gas turbine engine of any preceding clause, wherein the one or more graphene layers are integrated into an interior surface of one of the fan, the turbomachine, and the nacelle.

The gas turbine engine of any preceding clause, wherein the one or more graphene layers comprise a thickness of approximately 3 mil to approximately 100 mil.

The gas turbine engine of any preceding clause, further comprising an electrical heating element disposed in thermal communication with the one or more graphene layers.

The gas turbine engine of any preceding clause, further comprising an electrical supply assembly comprising an electrical supply cable in electrical communication with the electrical heating element.

The gas turbine engine of any preceding clause, further comprising a controller having one or more processors and one or more memory devices, the one or more memory devices storing instructions that when executed by the one or more processors cause the one or more processors to perform operations, in performing the operations, the one or more processors are configured to: receive an input indicating a change in a condition of the one of the fan, the turbomachine, and the nacelle; and in response to the change in the condition, cause the electrical supply assembly to provide power to the electrical heating element.

The gas turbine engine of any preceding clause, wherein the one or more graphene layers comprise graphene or an allotrope thereof.

An anti-ice assembly for a gas turbine engine, the gas turbine engine comprising a fan including a plurality of fan blades, a turbomachine operably coupled to the fan for driving the fan, the turbomachine including a compressor section, a combustion section, and a turbine section in serial flow order and together defining a core air flowpath, the anti-ice assembly comprising: one or more graphene layers coupled to, or integrated into, a portion of the gas turbine engine, wherein the one or more graphene layers are configured to reduce ice buildup or ice formation.

The anti-ice assembly of any preceding clause, further comprising a nacelle surrounding and at least partially enclosing the fan.

The anti-ice assembly of any preceding clause, wherein the one or more graphene layers are coupled to an external surface of one of the fan, the turbomachine, and the nacelle, wherein the external surface is exposed to a freeflow of air.

The anti-ice assembly of any preceding clause, wherein the one or more graphene layers are integrated into an interior surface of one of the fan, the turbomachine, and the nacelle.

The anti-ice assembly of any preceding clause, wherein the one or more graphene layers comprise a thickness of approximately 3 mil to approximately 100 mil.

The anti-ice assembly of any preceding clause, further comprising an electrical heating element disposed in thermal communication with the one or more graphene layers.

The anti-ice assembly of any preceding clause, further comprising an electrical supply assembly comprising an electrical supply cable in electrical communication with the electrical heating element.

The anti-ice assembly of any preceding clause, further comprising a controller having one or more processors and one or more memory devices, the one or more memory devices storing instructions that when executed by the one or more processors cause the one or more processors to perform operations, in performing the operations, the one or more processors are configured to: receive an input indicating a change in a condition of the one of the fan, the turbomachine, and the nacelle; and in response to the change in the condition, cause the electrical supply assembly to provide power to the electrical heating element.

The anti-ice assembly of any preceding clause, wherein the one or more graphene layers comprise graphene or an allotrope thereof.

An aircraft extending between a forward end and an aft end, the aircraft comprising: a fuselage extending longitudinally between the forward end of the aircraft and the aft end of the aircraft; and one or more graphene layers coupled to, or integrated into, a portion of the fuselage, wherein the one or more graphene layers are configured to reduce ice buildup or ice formation.

The aircraft of any preceding clause, wherein the one or more graphene layers comprise graphene or an allotrope thereof.

The aircraft of any preceding clause, wherein the one or more graphene layers are coupled to an external surface of the fuselage.

The aircraft of any preceding clause, wherein the one or more graphene layers are integrated into an interior surface of the fuselage.

The aircraft of any preceding clause, further comprising an electrical heating element disposed in thermal communication with the one or more graphene layers.

The aircraft of any preceding clause, further comprising an electrical supply assembly comprising an electrical supply cable in electrical communication with the electrical heating element.

The aircraft of any preceding clause, further comprising a controller having one or more processors and one or more memory devices, the one or more memory devices storing instructions that when executed by the one or more processors cause the one or more processors to perform operations, in performing the operations, the one or more processors are configured to: receive an input indicating a change in a condition of the fuselage; and in response to the change in the condition, cause the electrical supply assembly to provide power to the electrical heating element.

A gas turbine engine comprising: a fan comprising a plurality of fan blades; a turbomachine operably coupled to the fan for driving the fan; a nacelle surrounding and at least partially enclosing the fan; and an anti-icing system configured to reduce ice buildup or ice formation on one of the fan, the turbomachine, and the nacelle, the anti-icing system comprising: an electrical supply assembly comprising an electrical supply cable; a first anti-icing component in contact with the electrical supply assembly; and a second anti-icing component that is not in contact with the electrical supply assembly, wherein the second anti-icing component comprises an electromagnetic system.

The gas turbine engine of any preceding clause, further comprising a controller having one or more processors and one or more memory devices, the one or more memory devices storing instructions that when executed by the one or more processors cause the one or more processors to perform operations, in performing the operations, the one or more processors are configured to: receive a first input indicating a first change in a first condition of one of the fan, the turbomachine, and the nacelle; and in response to the first input, activate the electrical supply assembly to provide power to the first anti-icing component.

The gas turbine engine of any preceding clause, wherein the one or more processors are further configured to: receive a second input indicating a second change in a second condition of one of the fan, the turbomachine, and the nacelle; and in response to the second input, activate the second anti-icing component.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

While this disclosure has been described as having exemplary designs, the present disclosure can be further modified within the scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A gas turbine engine comprising:
a fan comprising a plurality of fan blades;
a turbomachine operably coupled to the fan for driving the fan, the turbomachine comprising a compressor section, a combustion section, and a turbine section in serial flow order and together defining a core air flowpath; and
one or more graphene layers coupled to, or integrated into, a portion of the gas turbine engine,
an electrical heating element disposed in thermal communication with at least one of the graphene layers,
wherein the one or more graphene layers are configured to reduce ice buildup or ice formation.

2. The gas turbine engine of claim 1, further comprising a nacelle surrounding and at least partially enclosing the fan.

3. The gas turbine engine of claim 2, wherein the one or more graphene layers are coupled to an external surface of one of the fan, the turbomachine, and the nacelle, wherein the external surface is exposed to a freeflow of air.

4. The gas turbine engine of claim 2, wherein the one or more graphene layers are integrated into an interior surface of one of the fan, the turbomachine, and the nacelle.

5. The gas turbine engine of claim 1, wherein the one or more graphene layers comprise a thickness of approximately 3 mil to approximately 100 mil.

6. (canceled)

7. The gas turbine engine of claim 1, further comprising an electrical supply assembly comprising an electrical supply cable in electrical communication with the electrical heating element.

8. The gas turbine engine of claim 7, further comprising a controller having one or more processors and one or more memory devices, the one or more memory devices storing instructions that when executed by the one or more processors cause the one or more processors to perform operations, in performing the operations, the one or more processors are configured to:
receive an input indicating a change in a condition of the one of the fan, the turbomachine, and the nacelle; and
in response to the change in the condition, cause the electrical supply assembly to provide power to the electrical heating element.

9. The gas turbine engine of claim 1, wherein the one or more graphene layers comprise graphene or an allotrope thereof.

10. An anti-ice assembly for a gas turbine engine, the gas turbine engine comprising a fan including a plurality of fan blades, a turbomachine operably coupled to the fan for driving the fan, the turbomachine including a compressor section, a combustion section, and a turbine section in serial flow order and together defining a core air flowpath, the anti-ice assembly comprising:
one or more graphene layers coupled to, or integrated into, a portion of the gas turbine engine,
an electrical heating element disposed in thermal communication with the one or more graphene layers,
wherein the one or more graphene layers are configured to reduce ice buildup or ice formation.

11. The anti-ice assembly of claim 10, further comprising a nacelle surrounding and at least partially enclosing the fan.

12. The anti-ice assembly of claim 11, wherein the one or more graphene layers are coupled to an external surface of one of the fan, the turbomachine, and the nacelle, wherein the external surface is exposed to a freeflow of air.

13. The anti-ice assembly of claim 11, wherein the one or more graphene layers are integrated into an interior surface of one of the fan, the turbomachine, and the nacelle.

14. (canceled)

15. The anti-ice assembly of claim 10, further comprising an electrical supply assembly comprising an electrical supply cable in electrical communication with the electrical heating element.

16. The anti-ice assembly of claim 15, further comprising a controller having one or more processors and one or more memory devices, the one or more memory devices storing instructions that when executed by the one or more processors cause the one or more processors to perform operations, in performing the operations, the one or more processors are configured to:
receive an input indicating a change in a condition of the one of the fan, the turbomachine, and the nacelle; and
in response to the change in the condition, cause the electrical supply assembly to provide power to the electrical heating element.

17. The anti-ice assembly of claim 10, wherein the one or more graphene layers comprise graphene or an allotrope thereof.

18. An aircraft extending between a forward end and an aft end, the aircraft comprising:
a fuselage extending longitudinally between the forward end of the aircraft and the aft end of the aircraft;
one or more graphene layers coupled to, or integrated into, a portion of the fuselage; and
an electrical heating element disposed in thermal communication with the one or more graphene layers,
wherein the one or more graphene layers are configured to reduce ice buildup or ice formation.

19. The aircraft of claim 18, further comprising:
an electrical supply assembly comprising an electrical supply cable in electrical communication with the electrical heating element; and
a controller having one or more processors and one or more memory devices, the one or more memory devices storing instructions that when executed by the one or more processors cause the one or more processors to perform operations, in performing the operations, the one or more processors are configured to:
receive an input indicating a change in a condition of the fuselage; and
in response to the change in the condition, cause the electrical supply assembly to provide power to the electrical heating element.

20. The aircraft of claim 18, wherein the one or more graphene layers comprise graphene or an allotrope thereof.
